(19) United States
(12) Patent Application Publication
(10) Pub. No.: US 2014/0020388 A1
(43) Pub. Date: Jan. 23, 2014

(54) SYSTEM FOR IMPROVED CARBON DIOXIDE CAPTURE AND METHOD THEREOF

(71) Applicants: Miguel Angel Gonzalez Salazar, Munich (DE); Parag Prakash Kulkarni, Niskayuna, NY (US); Vittorio Michelassi, Munich (DE)

(72) Inventors: Miguel Angel Gonzalez Salazar, Munich (DE); Parag Prakash Kulkarni, Niskayuna, NY (US); Vittorio Michelassi, Munich (DE)

(21) Appl. No.: 13/553,015

(22) Filed: Jul. 19, 2012

(51) Int. Cl. F01D 1/00; F25J 3/00; F02B 33/44

(52) U.S. Cl. 60/689; 62/617

(57) ABSTRACT

In one embodiment, a power plant is provided. The power plant includes a power generation system configured to produce an exhaust; a CO₂ separation system configured to receive the exhaust and configured to remove CO₂ therefrom, the CO₂ separation system being configured to produce a CO₂ stream; a heat recovery steam generator (HRSG) operatively coupled to the power generation system and the CO₂ separation system; and a CO₂ compression system configured to receive the CO₂ stream and configured to produce a CO₂ product stream.

### BACKGROUND OF THE INVENTION

The field of the invention relates generally to reducing CO₂ emissions from a power plant exhaust. More particularly, the invention relates to a natural gas combined cycle plant with an improved heat recovery steam generator and carbon capture system.

Power generating processes that are based on combustion of carbon containing fuel produce carbon dioxide as a byproduct. Typically, the CO₂ is one component of a mixture of gases that result from or pass unchanged through the combustion process. It may be desirable to capture or otherwise remove the CO₂ and/or other components of this gas mixture to prevent the release of these gases into the environment and/or utilize these gases in the power generation process or in other processes.

### BRIEF DESCRIPTION OF THE INVENTION

In one embodiment, a power plant is provided. The power plant includes a power generation system configured to produce an exhaust; a CO₂ separation system configured to receive the exhaust and configured to remove CO₂ therefrom, the CO₂ separation system being configured to produce a CO₂ stream; a heat recovery steam generator (HRSG) operatively coupled to the power generation system and the CO₂ separation system; and a CO₂ compression system configured to receive the CO₂ stream and configured to produce a CO₂ product stream.

In another embodiment, a CO₂ compression system for a power plant is provided. The compression system includes a CO₂ feed from a CO₂ separation system; a first compressor configured to provide a compressed CO₂ stream; a cooler configured to provide a cooled compressed CO₂ stream; a condenser configured to provide a CO₂ product stream; and a heat exchanger, wherein the heat exchanger is configured to provide heat exchange between at least a portion of the CO₂ product and steam extracted from a heat recovery steam generator (HSRG).

In yet another embodiment, a method for reducing CO₂ emissions in an exhaust stream is provided. The method includes generating an exhaust stream; extracting steam from a boiler system; separating CO₂ from the exhaust stream to produce a CO₂ stream; compressing the CO₂ stream to produce a compressed CO₂ stream; condensing the CO₂ stream in a condenser to produce a CO₂ product stream; and heating at least a portion of the CO₂ product stream against the extracted steam.

### BRIEF DESCRIPTION OF THE DRAWINGS

FIG. 1 is a schematic view of an exemplary power plant;

FIG. 2 is a partial schematic view of an exemplary heat recovery steam generator of FIG. 1;

FIG. 3 is a schematic view of an exemplary CO₂ compression system of FIG. 1;

FIG. 4 is a chart plotting net efficiency points and exhaust gas recirculation values; and

FIG. 5 is a chart plotting shaft power output and exhaust gas recirculation values.

### DETAILED DESCRIPTION OF THE INVENTION

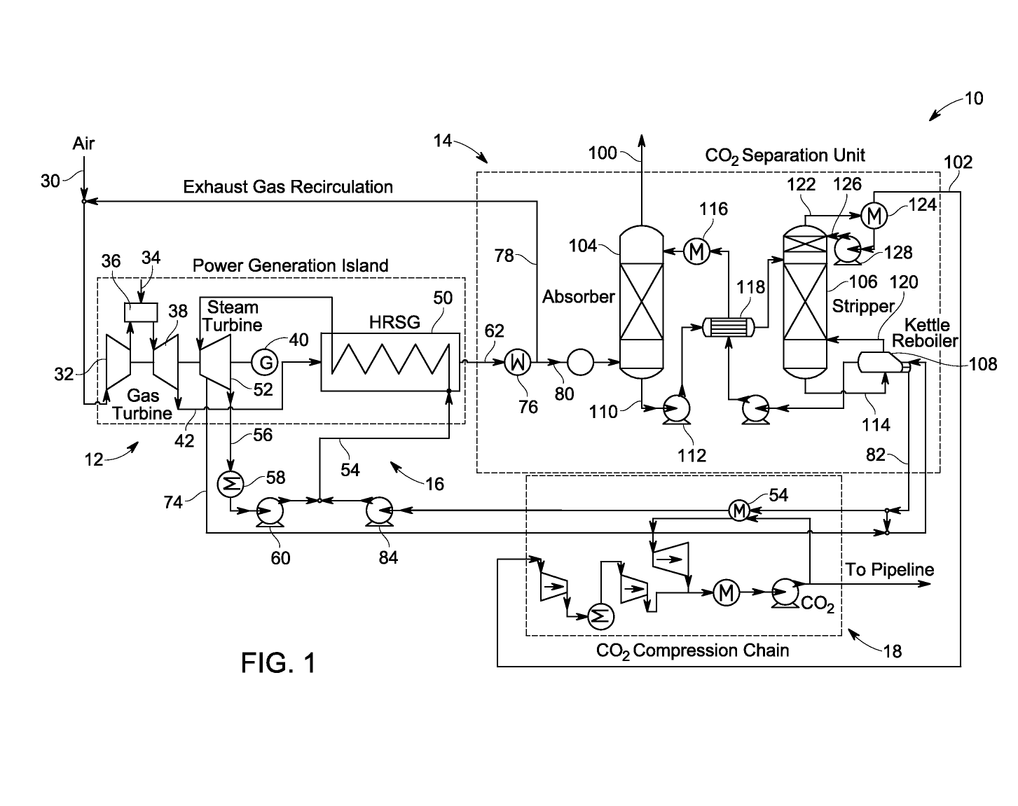

FIG. 1 illustrates an exemplary power plant 10. In the exemplary embodiment, power plant 10 is a natural gas combined cycle (NGCC) power plant. Generally, power plant 10 comprises a power generation system 12, a CO₂ separation system 14, a boiler system 16, and a CO₂ compression system 18.

In the exemplary embodiment, power generation system 12 comprises an air inlet 30, a compressor 32, a natural gas inlet 34, a combustor 36, and an expander 38 coupled to a generator 40. Air from air inlet 30 is compressed in compressor 32 and mixed with natural gas from natural gas inlet 34. Combustor 36 ignites and combusts the fuel-air mixture, and then passes hot pressurized exhaust gas into expander 38. Expander 38 may be a turbine including one or more stators having fixed vanes or blades, and one or more rotors having blades which rotate relative to the stators. Exhaust gas passes through the turbine rotor blades, thereby driving the turbine rotor to rotate which acts to generate power. Exhaust of the combustion process may exit expander 38 via an exhaust outlet 42. The configuration of power generation system 12 described herein is merely exemplary and it will be apparent to those skilled in the art that a variety of modifications and variations can be made to power generation system 12 without departing from the scope of the invention.

In the exemplary embodiment, boiler system 16 comprises a heat exchanger 50 and a steam turbine 52 coupled to generator 40. Compressor 32, expander 38 and steam turbine 52 are mounted on the same shaft, however steam turbine 52 is not fluidly connected to compressor 32 and expander 38. Heat exchanger 50 is a heat recovery steam regenerator (HRSG) to generate steam that is used to produce further power in steam turbine 52. Relatively hot exhaust gas from exhaust outlet 42 is channeled through HRSG 50. The heat energy from the hot exhaust stream is transferred to the working fluid flowing through HRSG 50. Heat exchanger 50 is an indirect heat exchanger in which water or steam is provided to and passes through first tubes (not shown) in heat exchanger 50 via conduit 54 and exhaust gas from exhaust outlet 42 is provided to and passes through second tubes (not shown) within heat exchanger 50.

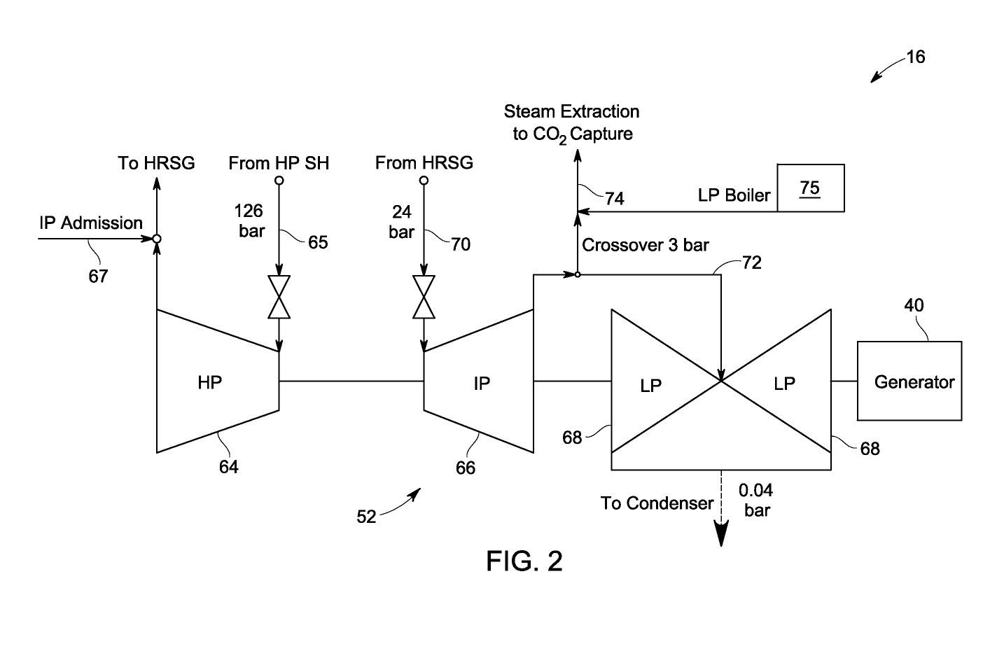

In the exemplary embodiment, steam exiting steam turbine 52 through conduit 56 passes through condenser 58 to convert the steam to water by lowering the temperature. A pump 60 may also be employed downstream of condenser 58 to increase the pressure of the water prior to entry into heat exchanger 50 via conduit 54. Steam may also be extracted from steam turbine 52 via conduit 74, as will be described below with further reference to FIG. 2.

FIG. 2 illustrates a partial schematic view of an exemplary embodiment of boiler system 16. In the exemplary embodiment, steam turbine 52 may comprise at least one high pressure (HP) stage 64, at least one intermediate pressure (IP) stage 66, and one or more low pressure (LP) stages 68 operatively coupled to generator 40.

In the exemplary embodiment, HP stage 64 receives steam at approximately 126 bar from a HP superheater (not shown) through conduit 65. Steam is expanded in HP stage 64 to approximately 25 bar and is mixed with steam from an IP superheater (not shown) through conduit 67. The steam mixture is delivered to heat exchanger 50 and ultimately through a conduit 70 to IP stage 66.

In the exemplary embodiment, IP stage 66 receives steam at approximately 24 bar from heat exchanger 50 via conduit 70. Steam is expanded in IP stage 66 and is delivered to LP stages 68 via crossover 72. The steam in crossover 72 is let down to a pressure of approximately 3 bar. At least a portion of steam in crossover 72 is expanded in LP stages 68 to approximately 0.04 bar and is delivered via conduit 56 to condenser 58.

In the exemplary embodiment, steam is extracted from boiler system 16 via extraction conduit 74 for use in CO₂ separation system 14 and CO₂ compression system (see FIG. 1), as will be described below. At least a portion of the steam in crossover 72 is extracted and delivered to extraction conduit 74. Steam may be let down to a pressure of 2-10 bar in extraction conduit 74. Further, in the exemplary embodiment, steam may also be extracted from a LP boiler 75 at approximately 2-10 bar and delivered to extraction conduit 74. In another embodiment, steam in crossover 72 and/or LP boiler 75 is extracted at or let down to a pressure of approximately 3 bar. The configuration of boiler system 16 described herein is merely exemplary and it will be apparent to those skilled in the art that a variety of modifications and variations can be made to boiler system 16 without departing from the scope of the invention.

With continued reference to FIG. 1, cooled exhaust gas exits heat exchanger 50 via conduit 62 where it may be further cooled in a heat exchanger 76. In the exemplary embodiment, a first flow of the exhaust gas is recirculated through an exhaust gas recirculation line 78 back to compressor 32. Recirculation line 78 increases CO₂ concentration in the exhaust gas and improves separation in CO₂ separation system 14. In some embodiments, up to about 20 volume %, or about 30 volume %, or about 40 volume %, or even up to about 50 volume % of the exhaust stream can be recycled to compressor 32 with air from air inlet 30. In the exemplary embodiment, a second flow of exhaust gas is provided to CO₂ separation system 14 via conduit 80.

In the exemplary embodiment, CO₂ separation system 14 is operable to produce a CO₂ depleted exhaust stream 100 and a CO₂ stream 102. In some embodiments, CO₂ separation system 14 comprises one or more separators, either used alone, or in combination with other CO₂ separation processes such as CO₂ selective membrane technologies, sorption processes, diaphragms, and the like. However, employment of other CO₂ separation units or flue-gas treatment units may be generally afforded benefits from the present technique. Exhaust stream 100 may exit CO₂ separation system 14 and be discharged to the environment. However, exhaust 100 may be further processed prior to discharge to the environment or elsewhere. At least a portion of CO₂ stream 102 may be pumped to supercritical pressure for transport (not shown).

In the exemplary embodiment, CO₂ separation system 14 generally comprises an absorber 104, a stripper 106, and a stripper reboiler 108. Exhaust gas in conduit 80 from steam turbine 52 is fed to absorber 104. The exhaust gas may be pretreated for removal of particulates and impurities such as SOx and NOx before entry into absorber 104.

In the exemplary CO₂ separation system 14, a solvent 110 rich in CO₂ exits the bottom of absorber 104 and is delivered via pump 112 to stripper 106. A solvent 114 lean in CO₂ exits the bottom of stripper 106 and is fed back to an upper portion of absorber 104 after being condensed in a condenser 116. Absorber 104 may be of any construction typical for providing gas-liquid contact and absorption. Absorber 104 and stripper 106 may incorporate a variety of internal components, such as trays, packings, supports, etc. The absorber 104 is configured to absorb CO₂ via a countercurrent flow from the entering exhaust gas. Stripper 106 is configured to remove CO₂ from solvent 110. The sizes of the absorber 104 and stripper 106 may generally be a function of the amount of CO₂ to be removed, and may be sized according to various engineering design equations. Furthermore, a single stripper 106 may serve multiple absorbers 104.

In the exemplary embodiment, the solvent may be a solution or dispersion, typically in water, of one or more absorbent compounds, that is, compounds which in water create an absorbent fluid that, compared to water alone, increases the ability of the fluid to preferentially remove carbon dioxide from exhaust gas in conduit 80. For example, the solvent may be monethanolamine (MEA). Inhibitors may be included in the solvent to inhibit degradation of the solvent.

In the exemplary embodiment, CO₂ rich solvent 110 is preheated in a countercurrent heat exchanger 118 against CO₂ lean solvent 114 and is subsequently fed to a top portion of stripper 106. Stripper 106 is a pressurized unit in which carbon dioxide is recovered from CO₂ rich solvent 110. Stripper 106 generally incorporates reboiler 108 which receives a portion of CO₂ lean solvent 114 exiting the bottom portion of stripper 106. Reboiler 108 vaporizes solvent 114 and provides solvent vapor 120 back to stripper 106 to increase CO₂ separation. A single stripper may include more than one reboiler 108. Reboiler 108 receives steam from extraction conduit 74 of boiler system 16 to provide heating duty in reboiler 108.

In the exemplary embodiment, vapor 122 exiting the top of stripper 106 is partially condensed in an overhead condenser 124. The condensed portion of vapor 122 is fed back to stripper 106 as reflux 126. Reflux 126 may be transferred through an accumulator (not shown) and a pump 128 before entry into stripper 106. CO₂ stream 102 is removed from condenser 124.

As mentioned, in the exemplary embodiment, CO₂ separation system 14 utilizes steam in extraction conduit 74 for use in reboiler 108. Advantageously, the present technique extracts saturated steam from at least one of crossover 72 between IP and LP stages 66 and 68, and LP boiler 75, at temperatures and pressures that prevent excessive heating to solvents in reboiler 108. For example, steam is extracted in conduit 74 at approximately 3 bar and 120-130° C., which is closer to the temperature and pressure required to operate reboiler 108. Extraction conduit 74 thus eliminates the need for a de-superheating process of steam used in the CO₂ separation system 14, thereby reducing heat loss and increasing overall system efficiency. The configuration of CO₂ separation system 14 described herein is merely exemplary and it will be apparent to those skilled in the art that a variety of modifications and variations can be made to CO₂ separation system 14 without departing from the scope of the invention.

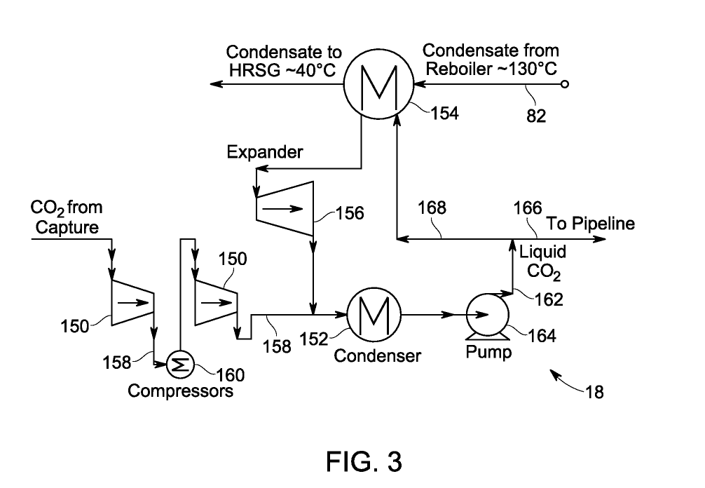

FIG. 3 is an exemplary embodiment of CO₂ compression system 18. Generally, CO₂ compression system 18 comprises one or more of the following: a compressor 150, a condenser 152, a heat exchanger 154, and an expander 156. At least a portion of CO₂ stream 102 from CO₂ separation system 14 is compressed in compressors 150 to provide a compressed CO₂ stream 158. An intercooler 160 may be provided between compressors 150. Compressed CO₂ stream 158 is cooled and condensed in condenser 152 to provide a liquid CO₂ product stream 162. CO₂ product stream 162 is pumped to a desired delivery pressure in pump 164 and a first portion 166 is sent to a pipeline or storage. A second portion 168 of CO₂ product stream is delivered to heat exchanger 154 for indirect heat exchange with a condensed steam stream 82 from reboiler 108. Second portion 168 is heated against stream 82 and then expanded in expander 156 to produce additional power. Power generated by expander 156 is used to power compressors 150, thereby increasing system efficiency. However, power generated in expander 156 may be utilized to power other systems or processes. Expanded second portion 168 is then combined with compressed CO₂ stream 158 upstream of condenser 152.

As described, in the exemplary embodiment, steam in extraction conduit 74 provides heating duty in reboiler 108 to vaporize solvent 114. Steam condensed in reboiler 108 is delivered as a saturated liquid at a temperature of approximately 130° C. via conduit 82 to either extraction conduit 74 for reintroduction into reboiler 108, or heat exchanger 154 for heat exchange with second portion 168. Condensed steam in conduit 82 is cooled to approximately 40° C. in heat exchanger 154 and pumped to a desired pressure in pump 84 before it is introduced into conduit 54 and returns to heat exchanger 50 of boiler system 16 (see FIG. 1). Thus, waste-heat is transferred from condensed steam in conduit 82 to high pressure CO₂ second portion 168 to produce power in expander 156. The configuration of CO₂ compression system 18 described herein is merely exemplary and it will be apparent to those skilled in the art that a variety of modifications and variations can be made to CO₂ compression system 18 without departing from the scope of the invention.

In the exemplary embodiment, the combination of steam extraction from crossover 72 and LP boiler 75 may be adjusted depending on the operating condition of power plant 10. Steam extraction from crossover 72 and/or LP boiler 75 is optimized for varying operating conditions such as, for example, startup, turndown, only power generation, power generation and partial CO₂ separation, and power generation and full CO₂ separation.

As described above, power plant 10 increases system efficiency by extracting steam from at least one of crossover 72 and LP boiler 75. System efficiency is further increased by transferring waste heat of condensed steam in conduit 82 to high pressure CO₂ 168 which is subsequently expanded in expander 156 to produce additional power. Further, system efficiency and CO₂ capture is increased by incorporating exhaust recirculation conduit 78 into system 10. More particularly, in the exemplary embodiment, the net efficiency of power plant 10 is reduced by approximately one net efficiency point and the power penalty of power plant 10 is reduced by approximately 10-12% (7-10 MW). The configuration of power plant 10 described herein is merely exemplary and it will be apparent to those skilled in the art that a variety of modifications and variations can be made to power plant 10 without departing from the scope of the invention.

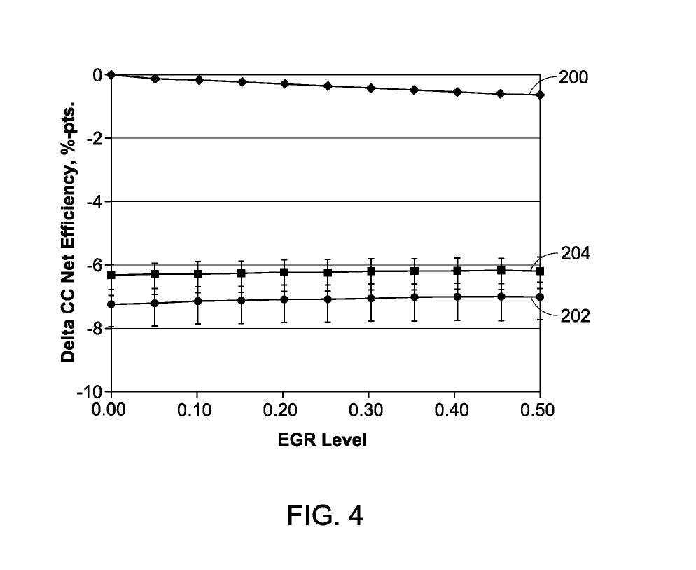

Shown in FIG. 4 is an exemplary plot of net efficiency points and exhaust gas recirculation levels of different combined cycle systems, which may include a carbon capture system. The exhaust gas recirculation (EGR) level is an operator controlled parameter of a combined cycle system, such as a natural gas combined cycle system. Typically, a combined cycle system runs at approximately 50% efficiency (i.e., 50 net efficiency points). However, when a carbon capture system is added to a combined cycle system, a reduction in efficiency occurs, which decreases the net efficiency points of a system. Line 200 plots the net efficiency points of a natural gas combined cycle system without a carbon capture system, and represents a baseline combined cycle system, such as a power plant. Line 202 plots the net efficiency points of a natural gas combined cycle system including an amine-based carbon capture system. As shown, a loss of approximately 7 efficiency points (i.e., an efficiency penalty) is incurred at all EGR levels when utilizing an amine-based carbon capture system. Line 204 plots the net efficiency points of a natural gas combined cycle system including an amine-based carbon capture system according to the present disclosure. As shown, an efficiency penalty of approximately 6 points is incurred. Thus, as shown in FIG. 4, the carbon capture system according to the present disclosure allows for the possibility of gaining 1 net efficiency point (a reduced penalty) for natural gas combined cycle systems in comparison to known carbon capture systems (i.e. line 202).

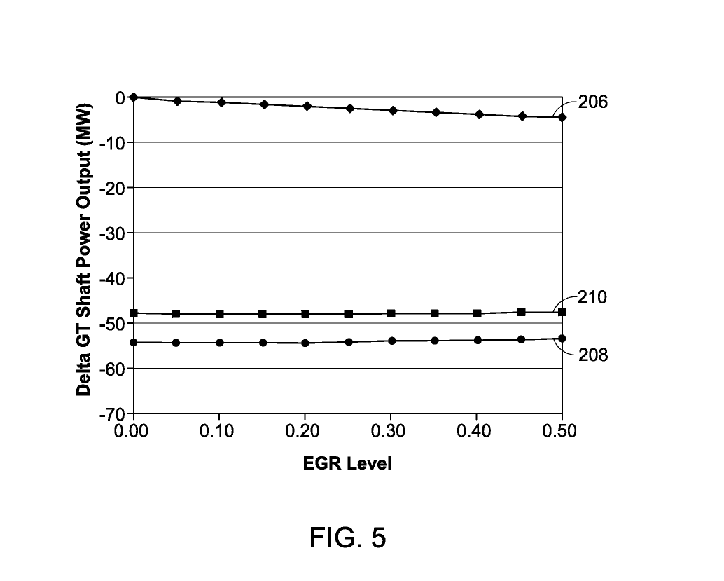

Shown in FIG. 5 is an exemplary plot of shaft power output and EGR levels of different combined cycle systems, which may include a carbon capture system. When a carbon capture system is added to a combined cycle system, a reduction in shaft power output occurs. Line 206 plots the shaft power output of a natural gas combined cycle system without a carbon capture system, and represents a baseline combined cycle system, such as a power plant. Line 208 plots the shaft power output of a natural gas combined cycle system including an amine-based carbon capture system. As shown, a loss of approximately 55 MW is incurred at all EGR levels when utilizing an amine-based carbon capture system. Line 210 plots the shaft power output of a natural gas combined cycle system including an amine-based carbon capture system according the present disclosure. As shown, a shaft power output penalty of approximately 47 MW is incurred. Thus, as shown in FIG. 5, the carbon capture system according to the present disclosure allows for the possibility of gaining 7-10 MW (a reduced penalty) for natural gas combined cycle systems in comparison to known carbon capture systems (i.e. line 208).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A power plant comprising:
a power generation system configured to produce an exhaust;
a CO₂ separation system configured to receive said exhaust and configured to remove CO₂ therefrom, said CO₂ separation system configured to produce a CO₂ stream;
a heat recovery steam generator (HRSG) operatively coupled to said power generation system and said CO₂ separation system; and
a CO₂ compression system configured to receive said CO₂ stream and configured to produce a CO₂ product stream.

2. The power plant of claim 1, wherein said HRSG comprises a conduit configured to provide steam to said CO₂ separation system for heat exchange therebetween.

3. The power plant of claim 2, wherein said conduit is an extraction conduit coupled to at least one of a crossover between an intermediate pressure turbine and a low pressure turbine of said HRSG, and a low pressure boiler of said HRSG.

4. The power plant of claim 3, wherein said extraction conduit is configured to extract said steam at between approximately 2 and 10 bar.

5. The power plant of claim 1, wherein said power generation system further includes an exhaust gas recirculation line.

6. The power plant of claim 1, wherein said CO₂ compression system comprises at least one compressor and a condenser, wherein said CO₂product stream is liquid.

7. The power plant of claim 6, wherein said CO₂ compression system further comprises at least two compressors and an intercooler therebetween.

8. The power plant of claim 6, wherein said CO₂ compression system further comprises a heat exchanger configured to provide heat exchange between a portion of said CO₂ product stream and steam extracted from said HRSG.

9. The power plant of claim 8, wherein said steam extracted from said HRSG is a condensed steam stream exiting said CO₂ separation system, said condensed steam configured to heat said portion of said CO₂ product stream, wherein said CO₂ compression system further comprises an expander configured to expand said heated CO₂ product stream to produce power.

10. A CO₂ compression system for a power plant, said compression system comprising:
a CO₂ feed from a CO₂ separation system;
a first compressor configured to provide a compressed CO₂ stream;
a cooler configured to provide a cooled compressed CO₂ stream;
a condenser configured to provide a CO₂ product stream; and
a heat exchanger, wherein said heat exchanger is configured to provide heat exchange between at least a portion of said CO₂ product stream and steam extracted from a heat recovery steam generator (HSRG).

11. The CO₂ compression system of claim 10, further comprising an extraction conduit thermally coupled to said heat exchanger, said extraction conduit coupleable to at least one of a crossover between an intermediate pressure turbine and a low pressure turbine of said HSRG, and a low pressure boiler of said HRSG.

12. The CO₂ compression system of claim 11, wherein said extraction conduit is configured to extract steam at between approximately 2 and 10 bar.

13. The CO₂ compression system of claim 10, further comprising an expander configured to expand a heated CO₂ product stream from said heat exchanger to produce power.

14. The CO₂ compression system of claim 13, wherein said expanded CO₂ product stream is introduced into said cooled compressed CO₂ stream.

15. The CO₂ compression system of claim 10, further comprising a second compressor, wherein said cooler is between said first and second compressors.

16. A method for reducing CO₂ emissions in an exhaust stream, comprising:
generating an exhaust stream;
extracting steam from a boiler system;
separating CO₂ from the exhaust stream to produce a CO₂ stream;
compressing the CO₂ stream to produce a compressed CO₂ stream;
condensing the CO₂ stream in a condenser to produce a CO₂ product stream; and
heating at least a portion of the CO₂ product stream against the extracted steam.

17. The method of claim 16, wherein said extracting steam from the boiler system comprises the step of extracting steam from at least one of a crossover between an intermediate pressure turbine and a low pressure turbine of the boiler system, and a low pressure boiler of the boiler system.

18. The method of claim 16, wherein the steam is extracted at approximately 3 bar.

19. The method of claim 16, further comprising expanding the at least a portion of the CO₂ product stream heated against the extracted stream to produce power.

20. The method of claim 19, further comprising reintroducing the expanded CO₂ stream into the compressed CO2 stream before said condenser.
